(19) United States
(12) Patent Application Publication
(10) Pub. No.: US 2024/0208445 A1
(43) Pub. Date: Jun. 27, 2024

(54) DATA PROCESSING DEVICE FOR MOTOR VEHICLE APPLICATIONS, MOTOR VEHICLE, AND METHOD FOR SPECIFYING A GROUP OF CONTROL COMMANDS FOR A MOTOR VEHICLE

(71) Applicant: AUDI AG, Ingolstadt (DE)

(72) Inventors: Tarik ABOUSENNA, Kösching (DE); Karsten BELZ, Ingolstadt (DE); Jörg DREXLER, Ingolstadt (DE); Alexander HEINZELMANN, Fürth (DE); Patrick LINS, Ingolstadt (DE); Sven MICHAELIS, München (DE); Jörg WALLNER, München (DE)

(73) Assignee: AUDI AG, Ingolstadt (DE)

(21) Appl. No.: 18/527,863

(22) Filed: Dec. 4, 2023

(30) Foreign Application Priority Data
Dec. 22, 2022 (DE) 102022134641.2

(51) Int. Cl. B60R 16/037; B60H 1/00; B60J 1/20; B60J 3/04; B60N 2/02; B60N 2/90; B60Q 3/80

(52) U.S. Cl. CPC B60R 16/037; B60H 1/00657; B60H 1/00835; B60J 1/2013; B60J 3/04; B60N 2/0237; B60N 2/976; B60Q 3/80; B60Q 1/04

(57) ABSTRACT

A method for specifying a group of control commands for a motor vehicle is based on the use of an NFT that links the access path for a group of control commands with owner and/or holder data and with identification data for the motor vehicle.

### FIELD

The invention relates to a data processing device for motor vehicle applications, it relates to a motor vehicle according to two aspects and a method for specifying a group of control commands for a motor vehicle.

### BACKGROUND

The data processing device for motor vehicle applications should in particular be one that takes on tasks centrally for a plurality of motor vehicles. Such a data processing device can, for example, be provided by the car manufacturer itself. This can also be referred to as a “platform”. The invention is particularly concerned with how different actuators in a vehicle can be controlled (“orchestrated”) in a combined form in order to provide the vehicle occupants with a specific user experience. In this context, DE 10 2020 105 854 A1 describes a platform for a vehicle for providing immersive user experiences. On the basis of a set profile, an orchestrated control of the vehicle's internal ambience takes place, in particular with a combination of visual, acoustic and olfactory elements.

US 2021/0133713 A1 discloses a system for managing asset rights based on distributed ledger networks—for example blockchain or DAG. In this context, a so-called non-fungible token is created, which represents the right to use the asset. A non-fungible token is also known in German as a “non-exchangeable token” (or: a non-replaceable token). Creating a non-exchangeable token is called “minting” in English, which is translated as “minting” in German.

The orchestration of different control devices in a motor vehicle is becoming increasingly more complex, precisely because a large number of actuators have to be activated at the same time. The user experiences should increasingly be designed to be variable over time. For example, you start to let the color of the interior lighting oscillate between two different shades. The design of such an interior experience can already have artistic quality or is at least technically complex. There is therefore an interest in ensuring that not everyone who owns a motor vehicle for which a particular user experience has been created has easy access to it without the designer being appropriately compensated for this.

### SUMMARY

It is an object of the invention to further develop the existing systems (data processing device for motor vehicle applications, motor vehicle) and to provide a corresponding method which is safer. The object is achieved by a processing device for motor vehicle applications, a motor vehicle in a first aspect, a motor vehicle in a second aspect, and by a method.

The invention is based on the use of an NFT (Non-Fungible Token) according to US 2021/0133713 A1, or also on the creation and sharing or selling of digital works of art via a network platform, as described in GB 2 601 894 A.

The data processing device according to the invention for motor vehicle applications comprises a server and a user interface. A file with a group of control commands for a motor vehicle is stored on the server. Such a file is known per se, for example in .xls format or as a .yaml file. The server has a transmission device which is designed to transmit an NFT associated with the file or an identifier for an NFT associated with the file to the motor vehicle. (The control commands for a motor vehicle may relate to a type of motor vehicle; however, the server always transmits the NFT to a specific motor vehicle, precisely so that the designer of the group of control commands can be appropriately compensated.) In the invention, the user interface is designed to receive a query from the motor vehicle as to whether actual information entered on the motor vehicle is identical to target information stored in the NFT. The actual information can be the name of a purchaser of the group of control commands, his identity card number, or the chassis number of the motor vehicle and the like. The query is then forwarded to the blockchain in the appropriate format, and the answer is received therefrom as to whether the actual information is identical to the target information. A release response is therefore received. In the invention, the transmitting device is further designed to send the control commands stored in the stored file to the motor vehicle in a predetermined time sequence when this confirmation/release response is received, which corresponds, preferably directly, to a time sequence of the implementation of the control commands. In other words, a form of on-demand delivery (“streaming”) is introduced for control commands of user experiences. This makes it possible for the control commands to be immediately implemented in the motor vehicle and then not to be retained, so that the user experience indirectly protected by the NFT (“file with a group of control commands”, such as a .yaml file) is protected. This means that copying of this file can be avoided and possible resale or unauthorized re-use etc. can be prevented.

The motor vehicle according to the invention has a first control device (or several such control devices) and is characterized by a receiving device which is designed to receive a plurality of control commands for this control device in a time sequence and to transmit them to the control device in accordance with the time sequence, wherein the control device is designed to implement the received control commands in accordance with the time sequence. Here, the passive side of on-demand transmission (“streaming”) is presented in addition to the data processing device.

It is preferably provided that each control command is deleted at a time after the arrival of a following control command for the control device. The ability of the motor vehicle to gradually receive control commands is used positively here in order to avoid that at some point the entire file with the control commands is stored in the motor vehicle.

The motor vehicle preferably has at least one second control device, and the receiving device is designed to receive control commands to be implemented simultaneously for the first and for the second control device in a data packet. For example, the data packet can have a header and then initially contain the commands for one control device and then the commands for the other control device (initially the first and then the second or vice versa). If the second control device is to cause a change in state while the first control device does not cause a change in state, control commands are only received for the second control device in the meantime. Conversely, this also applies to the first control unit. Absolute synchronicity is therefore not required. What is important, however, is that the form in which the data is transmitted, here as data packets, ensures possible synchronicity of actuator states, even if these states are not necessarily activated at the same time. (Example: First, a light-emitting diode switches to red, then a pleasant noise is emitted via the loudspeakers, which creates a feel-good atmosphere that matches the red light. The red light then continues to shine when the sound begins, so that there is synchronicity at the time the sound begins. Optionally, a command is repeated regarding the red light.)

To provide examples of the complexity of the orchestration, advantageous embodiments include a first and/or a second control device and/or a further control device in the motor vehicle (wherein there may be several first and/or several second control devices and/or several others control devices), which:
coordinate multiple displays,
control the interior light in the passenger compartment,
control shading devices (insulated windows, roller blinds),
move windows,
project images, videos and/or holograms in the passenger compartment,
control headlights, in particular matrix LED headlights,
control a subwoofer in at least one vehicle seat (“pleasant feeling for the corresponding occupant”),
control at least one air conditioning device (to produce a predetermined temperature and the like),
control an air outlet flap to determine an outflow direction (this is particularly consistent with the aforementioned or even independent of the specification of the temperature),
move elements of a seat (“comfort position”),
control at least one seat massage unit,
influences electromechanically controlled and/or pneumatically controlled chassis functions,
determine a passenger interior scenting,
determine an ionization of gas in the passenger compartment,
control an outside speaker,
control an acoustic system in the vehicle interior with regard to its settings, and/or
define the sounds reproduced by an acoustic system in the passenger compartment.

According to another preferred embodiment, the motor vehicle has a sensor device, wherein a control device is designed to receive measured values from the sensor device and to implement a received control command depending on at least one measured value. This implementation can consist of changing the control command, which itself provides a specific specification. Alternatively, it is possible for the control commands to simply specify a frame (“approximate command” or “parameter range”), so that the control unit can make a certain variation anyway, for example supported by artificial intelligence. A self-learning system can then convert the approximate control commands into concrete commands for the actuators.

According to a second aspect of the invention, the motor vehicle comprises a communication interface to a data processing device, in particular a data processing device according to the invention, wherein an NFT or an identifier for an NFT can be received via the communication interface. The motor vehicle further comprises an output device for outputting information related to the NFT/its identifier (“information data”), and it further comprises an input device for entering actual information, wherein the actual information entered as part of a query is transmitted to the data processing device via the communication interface. This is the complementary aspect of transmitting in the reverse direction to the previously mentioned direction of transmitting the control commands from the data processing device (the server) to the motor vehicle.

Further preferably, the two aspects of the motor vehicle are combined in one motor vehicle (also according to the preferred embodiments of these aspects).

The method according to the invention for specifying a group of control commands for a motor vehicle, in particular control commands for control devices related to a passenger interior of the motor vehicle, is characterized by:

receiving a data unit (file, for example: “.yaml file”) containing the group of control commands, by a server. (this step may include the designer of the user experience in the passenger compartment overwriting the data unit/file etc.) The data unit is stored on a storage device of the server. An access path to the data unit of the storage device is defined or named. An NFT is then minted, which links the access path with owner and/or holder data and with identification data for the motor vehicle. (NFTs are known to link multiple pieces of information in a non-interchangeable manner.) The method proceeds with entering the NFT into a blockchain (to ensure protection). The NFT or an identifier of the NFT is then transmitted to the motor vehicle identified by the identification data. This may occur due to a request from the owner of the motor vehicle. There can also be an automation within the data processing device/server. The owner and/or holder data should then be confirmed by a vehicle occupant. (It was already mentioned above that the NFT data or an identifier for these or data derived therefrom are made available to the vehicle occupant on an output device (preferably: display device, display).) For the purpose of confirmation, the vehicle occupant provides an actual Information, such as his name, his identity card number or the like, which is information that corresponds to target information in the NFT, i.e. was included when the NFT was minted. The actual information is transmitted to the data processing device/server as part of a query, and it is then forwarded to the blockchain in a corresponding query. The format of the forwarded query can be adapted by the data processing device/server to the requirements of the blockchain. The blockchain checks whether the actual information matches the target information and, if so, a release response is sent to the data processing device/server and preferably from this to the motor vehicle.

An automatic transmission of the control commands, which are found in the NFT using the access path, can then begin through the server to the motor vehicle.

Similar to NFTs used to sell works of art, the NFT minted in this method specifies an access path through which the object to be purchased can be found. In the present case, the object is the group of control commands (“.yaml file” or similar). The authorized person is identified by linking to the owner and/or holder data (owner: when purchasing; holder: when renting or leasing). Due to the identification data, this only applies to a specific motor vehicle.

Preferably, the control commands are sent to the motor vehicle in a (predetermined) time sequence and deleted again after their use and/or after receipt of a subsequent command. The advantages of this embodiment have already been discussed above.

According to a further preferred embodiment of the method, the data processing device mediates a transfer of ownership and/or holdership of the group of control commands before the NFT is minted. For example, a purchase of the NFT and thus of the user experience can be made using the data processing device. As explained above, the data processing device here has the function of a platform, such as that provided by the automobile manufacturer.

For applications or situations that can arise in the method and which are not explicitly described here, according to the method, an error message and/or a request for user feedback input is issued and/or a default setting and/or a predetermined initial state are set.

The control commands mentioned are directed to a control device. The control device can have a data processing device or a processor device which is configured to perform an embodiment of the method according to the invention. For this purpose, the processor device can have at least one microprocessor and/or at least one microcontroller and/or at least one FPGA (Field Programmable Gate Array) and/or at least one DSP (Digital Signal Processor). The processor device can also comprise program code, which is designed to perform, upon execution by the processor device, the embodiment of the method according to the invention. The program code can be stored in a data storage of the processor device. A processor circuit of the processor device can have, for example, at least one circuit board and/or at least one SoC (System on Chip).

The invention also includes developments of the method according to the invention, which have features as already described in the context of the developments of the motor vehicle according to the invention. For this reason, the corresponding developments of the method according to the invention are not described again here.

The motor vehicle according to the invention is preferably designed as an automobile, in particular as a passenger car or truck, or as a passenger bus or motorcycle.

In a further solution, the invention also comprises a computer-readable storage medium, comprising commands which, when executed by a computer or a computer network, cause it to execute an embodiment of the method according to the invention. The storage medium can be embodied, for example, at least partially as a non-volatile data memory (such as a flash memory and/or as an SSD—solid state drive) and/or at least partially as a volatile data memory (such as a RAM—random access memory). However, the storage medium can also be operated, for example, as a so-called app store server on the Internet. A processor circuit with at least one microprocessor can be provided by the computer or computer network. The commands can be provided as binary code or assembler and/or as source code of a programming language (such as C).

The invention also comprises the combinations of the features of the described embodiments. The invention therefore also comprises implementations that each have a combination of the features of several of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic diagram of the components used to implement the invention and their functions;

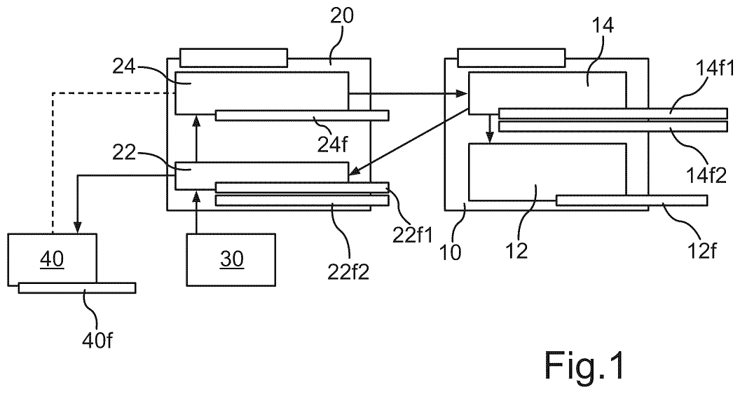

FIG. 2 shows the steps of an embodiment of the method according to the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

The aim is to provide an experience for the vehicle occupants in the passenger compartment by controlling, in particular, those actuators that affect the passenger interior, and possibly also actuators that affect the outside world. A plurality of actuators are coordinated so that the control commands are “orchestrated”. The vehicle user can purchase such user experiences, either for one-time use or as a permanent device for the motor vehicle 10. There is a central data processing device 20, for example from the car manufacturer, which includes a front-end application 22 (program running on a processor or another data processing unit). The front-end application provides the actual platform so that users 30 can perform actions for their motor vehicle 10. The backend of the data processing device 20 consists of the server 24. It is a safe server with configuration data records. In particular, so-called .yaml files are stored on the server 24 (“Config files”), wherein its task (function) according to 24f is to store these Config files.

In order for these groups of control commands in the Config files to function reliably as data units (files), the designers of the user experience for the vehicle 10 (and other vehicles of the same type) protect the Config file. One function of the front-end application according to 22f1 is to enable the purchase, sale or licensing of the rights to the user experience in the form of NFTs. These NFTs are created and at the same time an identity of the user 30 and a chassis number of the motor vehicle 10 (or other identity features thereof) are made available in the NFT. A previously existing NFT is updated so that the new owner and holder rights (usage rights, etc.) are now included in the blockchain 40 with the NFTs. According to 40f, the function of the blockchain 40 is to secure the rights. When minting the NFT, a path to the group of control commands (Config file) in the server 24 is linked to the other data mentioned. In this way, it can be seen from the NFT where the acquired data is located on the server 24. The NFT or preferably just an identifier for the NFT is transmitted to a front-end application (“app”) 14, which is provided in the motor vehicle 10. (The identifier can include an identification number for the NFT, a short name, a hash value, or the like). The task of the front-end application is to mediate the reception of the control commands, which are then forwarded to the actuators 12 (for conditioning, light, seat and the like). The task of the actuators according to 12f is to set the settings in the vehicle. The task of the front-end application (a program that runs on a suitable processor or other data processing unit) is, according to function 14f1, to initially display the NFTs or a respective identifier number in the vehicle. Via a user interface (display as output device and actuation device), the user can see which identification the NFT or identifier indicates and in particular confirm her own identity and enter actual information. A corresponding query is then transmitted according to the arrow from 14 to 22 to the front-end application 22, the function 22f2 of which is now to legitimize access to the group of control commands (“Config file”). The function 14f2 of the front-end application 14 in the motor vehicle is to ensure the legitimacy of the displayed NFT or the NFT defined by the displayed identifier by querying and receiving a response. The query is passed on to the blockchain by the front-end application 22, so the legitimacy of the user's rights is checked according to 40f, and a corresponding answer is transmitted to the front-end application 14 via the return path via the server 24.

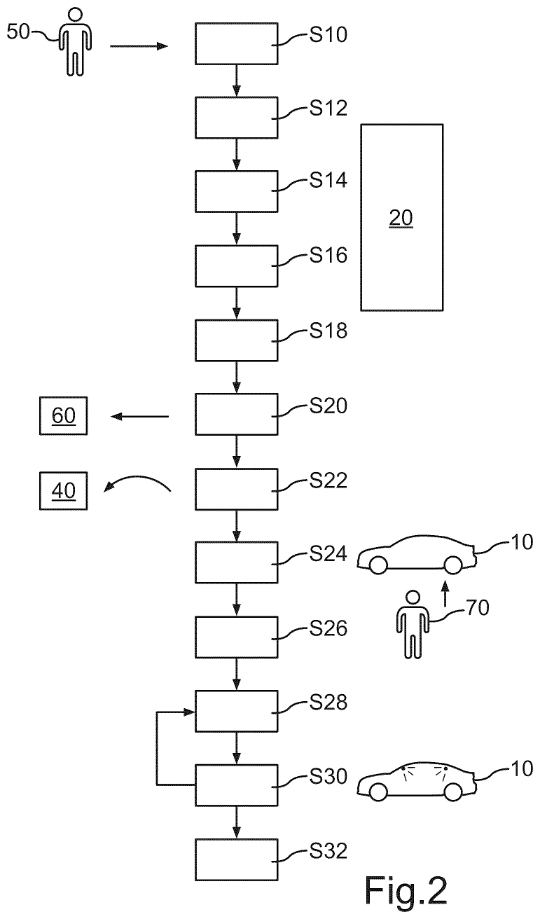

The steps of an embodiment of the method according to the invention are explained below with reference to FIG. 2.

The method for specifying a group of control commands for the motor vehicle 10 initially comprises designing this group of control commands (“user experience”) as an orchestration of actuators by a designer 50, step S10. Technically, the method by the server begins with step S12: the server receives a data unit (“Config file”) with the group of control commands. According to step S14, the data unit is stored on a storage device of the server 24. In the subsequent step S16, an access path to the data unit of the storage device is defined/named. In step S18, the front-end application 22 conveys a transfer of ownership and/or possession of the group of control commands to a buyer. The NFT 60 is then minted in step S20, which links the access path with owner and/or holder data and with identification data for the motor vehicle 10. In step S22, the NFT is entered into the blockchain 40.

Furthermore, in step S24, an identifier for the NFT (or the NFT as such) is transmitted to the vehicle 10 identified by the identification data, so that from then on the method can (also) be described on the vehicle's side 10. There, in step S26, the correctness of the owner and/or owner data is queried by a vehicle occupant 70. For example, the vehicle occupant 70 is shown a short name for the desired functions or another identifier for the NFT and the functions, and is prompted, for example, to enter data as actual information to confirm his identity. A query is made via the front-end application 22 as to whether the user identified in this way is actually the owner and/or holder of the function, i.e. whether the actual information is identical to target information which is stored in the NFT. After confirming the owner and/or holder data by querying of the blockchain and its replying, the control commands found using the access path are automatically transmitted by the server 20 to the motor vehicle 10 in step S28. The process continues here in the server and also in the motor vehicle. The motor vehicle 10 receives the control commands and implements these control commands, symbolized here by glowing lamps in the passenger compartment. In step S30, the control commands that have already been used are deleted. The method then goes to step S28 again and receives the next data packet or, if several data packets are transmitted, one of the next data packets before deletion in step S30. The data packets can be determined by changes or simply be the result of timing the transmission of control commands. The method ends in step S32.

Overall, the examples show how an InCar NFT use of NFT can be provided as an ownership and distribution concept for orchestrated vehicle functionality.

1. A data processing device for motor vehicle applications, with a server and a user interface, wherein a file with a group of control commands for a motor vehicle is stored on the server and the server has a transmitting device which is designed to transmit an NFT associated with the file or an identifier for an NFT associated with the file to the motor vehicle,
wherein the user interface is designed to receive a query from the motor vehicle by transmitting actual information, and to send a corresponding query to a blockchain as to whether this actual information is identical to target information, which is stored in the NFT, and in that the user interface is designed to receive confirmation from the blockchain, that the actual information is identical to the target information, and
wherein, when the confirmation is received from the blockchain, the sending device further sends the control commands stored in the stored file to the motor vehicle in a predetermined time sequence, which corresponds to a time sequence of the implementation of the control commands.

2. A motor vehicle with a first control device, further comprising:
a receiving device which is designed to receive a plurality of control commands for this first control device in a time sequence and to transmit them to the control device in accordance with the time sequence, wherein the control device is designed to implement the received control commands in accordance with the time sequence.

3. The motor vehicle according to claim 2, in which each control command is deleted at a time after the arrival of a subsequent control command for the control device.

4. The motor vehicle according to claim 2, with at least one second control device, wherein the receiving device is designed to receive control commands to be implemented simultaneously for the first and for the second control device in a data packet.

5. The motor vehicle according to claim 2, wherein a first control device and/or a second control device and/or a further control device:
coordinates multiple displays,
controls the interior light in the passenger compartment,
controls shading devices (insulated windows, roller blinds),
moves windows,
projects images, videos and/or holograms in the passenger compartment,
controls headlights, especially matrix LED headlights,
controls a subwoofer in at least one vehicle seat,
controls at least one air conditioning device,
controls an air outlet flap to determine an outflow direction),
moves elements of a seat (“comfort position”),
controls at least one seat massage unit,
influences electromechanically controlled and/or pneumatically controlled chassis functions,
determines a passenger interior fragrancing,
determines an ionization of gas in the passenger compartment,
controls an outside speaker,
controls an acoustic system in the vehicle interior with regard to its settings, and/or
defines the sounds reproduced by an acoustic system in the passenger compartment.

6. The motor vehicle according to claim 2, with a sensor device, wherein at least one control device is designed to receive measured values from the sensor device and to implement, preferably change, a received control command depending on at least one measured value.

7. A motor vehicle with a communication interface to a data processing device, in particular a data processing device according to claim 1, wherein an NFT or an identifier for an NFT can be received via the communication interface, and with an output device for outputting information which is related to the NFT, and with an input device for entering actual information, wherein the actual information is transmitted to the data processing device via the communication interface.

8. A method for specifying a group of control commands for a motor vehicle, in particular control commands for control devices related to a passenger interior of the motor vehicle, comprising:
receiving a data unit with the group of control commands by a server,
storing the data unit on a storage device of the server,
defining an access path to the data unit in the storage device,
minting an NFT, which links the access path with owner and/or holder data and with identification data for the motor vehicle,
entering the NFT into a blockchain,
transmitting the NFT or an identifier of the NFT to the motor vehicle identified by the identification data,
sending a query to confirm the owner and/or holder data by a vehicle occupant,
transmitting the query to the blockchain,
confirming the query by the blockchain,
automatically transmitting the control commands found using the access path by the server (24) to the motor vehicle.

9. The method according to claim 8,
wherein the control commands are sent to the motor vehicle in time sequence and are deleted again after their use and/or after receipt of a subsequent command.

10. The method according to claim 8,
wherein the data processing device mediates a transfer of ownership and/or holdership of the group of control commands before the NFT is minted.

11. The motor vehicle according to claim 3, with at least one second control device, wherein the receiving device is designed to receive control commands to be implemented simultaneously for the first and for the second control device in a data packet.

12. The motor vehicle according to claim 3, wherein a first control device and/or a second control device and/or a further control device:
coordinates multiple displays,
controls the interior light in the passenger compartment,
controls shading devices (insulated windows, roller blinds),
moves windows,
projects images, videos and/or holograms in the passenger compartment,
controls headlights, especially matrix LED headlights,
controls a subwoofer in at least one vehicle seat,
controls at least one air conditioning device,
controls an air outlet flap to determine an outflow direction),
moves elements of a seat (“comfort position”),
controls at least one seat massage unit,
influences electromechanically controlled and/or pneumatically controlled chassis functions,
determines a passenger interior fragrancing,
determines an ionization of gas in the passenger compartment,
controls an outside speaker,
controls an acoustic system in the vehicle interior with regard to its settings, and/or
defines the sounds reproduced by an acoustic system in the passenger compartment.

13. The motor vehicle according to claim 4, wherein a first control device and/or a second control device and/or a further control device:
coordinates multiple displays,
controls the interior light in the passenger compartment,
controls shading devices (insulated windows, roller blinds),
moves windows,
projects images, videos and/or holograms in the passenger compartment,
controls headlights, especially matrix LED headlights,
controls a subwoofer in at least one vehicle seat,
controls at least one air conditioning device,
controls an air outlet flap to determine an outflow direction),
moves elements of a seat (“comfort position”),
controls at least one seat massage unit,
influences electromechanically controlled and/or pneumatically controlled chassis functions,
determines a passenger interior fragrancing,
determines an ionization of gas in the passenger compartment,
controls an outside speaker,
controls an acoustic system in the vehicle interior with regard to its settings, and/or
defines the sounds reproduced by an acoustic system in the passenger compartment.

14. The motor vehicle according to claim 3, with a sensor device, wherein at least one control device is designed to receive measured values from the sensor device and to implement, preferably change, a received control command depending on at least one measured value.

15. The motor vehicle according to claim 4, with a sensor device, wherein at least one control device is designed to receive measured values from the sensor device and to implement, preferably change, a received control command depending on at least one measured value.

16. The motor vehicle according to claim 5, with a sensor device, wherein at least one control device is designed to receive measured values from the sensor device and to implement, preferably change, a received control command depending on at least one measured value.

17. The method according to claim 9,
wherein the data processing device mediates a transfer of ownership and/or holdership of the group of control commands before the NFT is minted.
